(19) United States
(12) Patent Application Publication
(10) Pub. No.: US 2008/0204762 A1
(43) Pub. Date: Aug. 28, 2008

(54) Methods, systems, and computer program products for removing undesired artifacts in fourier domain optical coherence tomography (FDOCT) systems using integrating buckets

(75) Inventors: Joseph A. Izatt, Raleigh, NC (US); Yuankai K. Tao, Durham, NC (US); Mingtao Zhao, Durham, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: Duke University

(21) Appl. No.: 12/009,329

(22) Filed: Jan. 17, 2008

Related U.S. Application Data
(60) Provisional application No. 60/880,916, filed on Jan. 17, 2007.

(51) Int. Cl. G01B 9/02

(52) U.S. Cl. 356/521

(57) ABSTRACT

Methods, systems, and computer program products for removing undesired artifacts in Fourier domain optical coherence tomography (FDOCT) systems using integrating buckets are disclosed. According to one aspect, a method includes introducing a variable phase delay between a reference arm and a sample arm of an FDOCT interferometer using sinusoidal phase modulation. Further, the method includes acquiring an interferometric intensity signal using an integrating buckets technique. The method also includes resolving the interferometric intensity signal to remove undesired artifacts.

### RELATED APPLICATIONS

The presently disclosed subject matter claims the benefit of U.S. Provisional Patent Application Ser. No. 60/880,916, filed Jan. 17, 2007, the disclosure of which is incorporated herein by reference in its entirety.

### GOVERNMENT INTEREST

This presently disclosed subject matter was made with U.S. Government support under Grant Nos. R21 RR019769 and R21 EY017393 awarded by National Institutes of Health (NIH). Thus, the U.S. Government has certain rights in the presently disclosed subject matter.

### TECHNICAL FIELD

The subject matter disclosed herein generally relates to optical coherence tomography (OCT). More particularly, the subject matter disclosed herein relates to systems, methods, and computer program products for removing undesired artifacts in Fourier domain optical coherence tomography (FDOCT) systems.

### BACKGROUND

Optical coherence tomography (OCT) is a noninvasive imaging technique that provides microscopic tomographic sectioning of biological samples. By measuring singly backscattered light as a function of depth, OCT fills a valuable niche in imaging of tissue ultrastructure, providing subsurface imaging with high spatial resolution (about 2.0-10.0 μm) in three dimensions and high sensitivity (>110 dB) in vivo with no contact needed between the probe and the tissue.

In biological and biomedical imaging applications, OCT allows for micrometer-scale imaging non invasively in transparent, translucent, and/or highly-scattering biological tissues. The longitudinal ranging capability of OCT is generally based on low-coherence interferometry, in which light from a broadband source is split between illuminating the sample of interest and a reference path. The interference pattern of light reflected or backscattered from the sample and light from the reference delay contains information about the location and scattering amplitude of the scatterers in the sample. In time-domain OCT (TDOCT), this information is typically extracted by scanning the reference path delay and detecting the resulting interferogram pattern as a function of that delay. The envelope of the interferogram pattern thus detected represents a map of the reflectivity of the sample versus depth, generally called an A-scan, with depth resolution given by the coherence length of the source. In OCT systems, multiple A-scans are typically acquired while the sample beam is scanned laterally across the tissue surface, building up a two-dimensional map of reflectivity versus depth and lateral extent typically called a B-scan. The lateral resolution of the B-scan is approximated by the confocal resolving power of the sample arm optical system, which is usually given by the size of the focused optical spot in the tissue.

The time-domain approach used in conventional OCT, including commercial instruments, such as Carl Zeiss Meditec's STRATUSOCT® and VISANTE® products, has been successful in supporting biological and medical applications, and numerous in vivo human clinical trials of OCT reported to date have utilized this approach.

An alternate approach to data collection in OCT has been shown to have significant advantages both in reduced system complexity and in increased signal-to-noise ratio (SNR). This approach involves acquiring the interferometric signal generated by mixing sample light with reference light at a fixed group delay as a function of optical wavenumber. Two distinct techniques have been developed which use this Fourier domain OCT (FDOCT) approach. The first, generally termed Spectral-domain or spectrometer-based OCT (SDOCT), uses a broadband light source and achieves spectral discrimination with a dispersive spectrometer in the detector arm. The second, generally termed swept-source OCT (SSOCT) or optical frequency-domain imaging (OFDI), time-encodes wavenumber by rapidly tuning a narrowband source through a broad optical bandwidth. Both of these techniques may allow for a dramatic improvement in SNR of up to 15.0-20.0 dB over time-domain OCT, because they typically capture the A-scan data in parallel. This is in contrast to previous-generation time-domain OCT, where destructive interference is typically used to isolate the interferometric signal from only one depth at a time as the reference delay is scanned.

In both spectrometer-based and swept-source implementations of FDOCT, light returning from all depths is generally collected simultaneously, and is manifested as modulations in the detected spectrum. Transformation of the detected spectrum from wavelength to wavenumber, correction for dispersion mismatches between the sample and reference arms, and Fast Fourier transformation typically provides the spatial domain signal or “A-scan” representing depth-resolved reflectivity of the sample. The uncorrected A-scan may also include a strong DC component at zero pathlength offset, so-called “autocorrelation” artifacts resulting from mutual interference between internal sample reflections, as well as both positive and negative frequency components of the depth-dependent cosine frequency interference terms. Because of this, FDOCT systems typically exhibit “complex conjugate artifact” due to the fact that the Fourier transform of a real signal, the detected spectral interferogram, is typically Hermitian symmetric, i.e., positive and negative spatial frequencies are not independent. As a consequence, sample reflections at a positive displacement, relative to the reference delay, typically cannot be distinguished from reflections at the same negative displacement, and appear as upside-down, overlapping images on top of genuine sample structure, which generally cannot be removed by image processing. To reduce the likelihood of the occurrence of this symmetry artifact, FDOCT imaging is commonly performed with the entire sample either above or below the reference position, generally limiting the technique to thin samples of 2.0-4.0 mm, and placing the region of maximum SNR, at zero spatial frequency, outside the imaged structure. Resolving this artifact could effectively double the imaging depth, as well as allow the operator to position the most critical region of the sample at the position of maximum SNR.

Developments in FDOCT have shown clinical potential, particularly in retinal imaging, where current generation SDOCT systems allow for high-resolution, motion-artifact-free cross-sectional imaging and rapid volume dataset acquisition. As discussed hereinabove, FDOCT suffers from complex conjugate or mirror image artifacts, in which positive and negative distances relative to the reference pathlength cannot be uniquely resolved. As noted above, current imaging practice avoids this artifact by limiting the sample entirely on one side of the reference pathlength, utilizing only half of the total potential imaging depth. Such imaging practices are sufficient when imaging normal retina and pathologies which fit within about 1-2 mm imaging range of current SDOCT systems, however conjugate artifacts complicate images acquired from patients with poor fixation or head control, and imaging of extended pathologies (such as vitreous strands, deep optic nerve head cups, and choroidal structures) would benefit from full range imaging since sensitivity is limited by the characteristic roll-off associated with the finite spectral resolution of SDOCT systems.

Several approaches for complex conjugate artifact (CCA) removal have been demonstrated, many of which borrow from established techniques of phase shift interferometry for acquiring phase-encoded interferometric signals. These include phase shifting acquired from interferograms by discretely stepping piezoelectric transducer (PZT)-mounted reference reflectors (described, for example, in the article Ultrahigh-Resolution, High-Speed, Fourier Domain Optical Coherence Tomography and Methods for Dispersion Compensation, Wojtkowski et al., Optics Express 12, 2404 (2004), the content of which is incorporated herein by reference in its entirety), electro-optic modulator (described, for example, in the article High Speed Full Range Complex Spectral Domain Optical Coherence Tomography, Gotzinger et al., Optics Express 13, 583 (2005), the content of which is incorporated herein by reference in its entirety), acousto-optic modulator (described, for example, in the article Heterodyne Fourier Domain Optical Coherence Tomography for Full Range Probing with High Axial Resolution, Bachmann et al., Optics Express 14, 1487 (2006), the content of which is incorporated herein by reference in its entirety), instantaneous phase-shifted interferograms acquisition using 3×3 interferometers (described, for example, in the article Real-Time Quadrature Projection Complex Conjugate Resolved Fourier Domain Optical Coherence Tomography, Sarunic et al., Opt Lett 31, 2426 (2006), the content of which is incorporated herein by reference in its entirety) or polarization encoding (described, for example, in the article Elimination of Depth Degeneracy in Optical Frequency-Domain Imaging Through Polarization-Based Optical Demodulation, Vakoc et al., Opt Lett 31, 362 (2006), the content of which is incorporated herein by reference in its entirety), and harmonic lock-in detection of sinusoidal reference phase modulation (described, for example, in the article Resolving the Complex Conjugate Ambiguity in Fourier-Domain OCT by Harmonic Lock-In Detection of the Spectral Interferogram, Vakhtin et al., Opt Lett 31, 1271 (2006), the content of which is incorporated herein by reference in its entirety). Only a few of these techniques may be suitable for high-speed imaging (i.e., about 20 kHz A-scan rate), and of those many require expensive and cumbersome components (electro-optic of acousto-optic modulators, multiple spectrometers). Discretely stepped reference arm phase shifting techniques are limited by the response time of the PZT used.

Accordingly, for the reasons set forth above, it is desirable to provide improved FDOCT systems and methods for removing undesired artifacts. In particular, it is desirable to provide improved SDOCT systems and methods for providing biological sample images such as retinal images.

### SUMMARY

Methods, systems, and computer program products are disclosed that use integrating buckets techniques for removing undesired artifacts in Fourier domain optical coherence tomography (FDOCT) systems. According to one aspect, a method includes introducing a variable phase delay between a reference arm and a sample arm of an FDOCT interferometer using sinusoidal phase modulation. Further, the method includes acquiring an interferometric intensity signal using an integrating buckets technique. The method also includes resolving the interferometric intensity signal to remove undesired artifacts.

According to another aspect, an FDOCT system includes a reference arm and a sample arm of an FDOCT interferometer. The system also includes a phase controller configured to introduce a variable phase delay between the reference arm and the sample arm using sinusoidal phase modulation. Further, the system includes a signal receiver configured to acquire an interferometric intensity signal using an integrating buckets technique. The system also includes an artifact resolve function configured to resolve the interferometric intensity signal to remove undesired artifacts.

The subject matter described herein may be implemented using a computer program product comprising computer executable instructions embodied in a computer readable medium. Exemplary computer readable media suitable for implementing the subject matter described herein include chip memory devices, disc memory devices, application specific integrated circuits, programmable logic devices, and downloadable electrical signals. In addition, a computer program product that implements a subject matter described herein may reside on a single device or computing platform or maybe distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a schematic block diagram of an FDOCT system including a piezoelectric transducer (PZT) element in accordance with the subject matter disclosed herein;

FIG. 2 is a flow chart of an exemplary process for removing undesired artifacts in an FDOCT system according to an embodiment of the subject matter disclosed herein;

FIG. 3 is a schematic block diagram of an FDOCT retinal imaging system in accordance with the subject matter disclosed herein;

FIG. 4 is a graph showing plots of meshes for each constraint on Gₚ(ψ,θ) and Hₚ(ψ,θ) as functions of ψ and θ to determine points of intersection;

FIG. 5 is a graph showing plots of the meshes shown in FIG. 4;

FIG. 6 is a graph showing a result of using a sinusoidal driving signal at 11.6 Vₚₚ and 341° phase offset, where the calculated mean phase step during one frame between buckets 1-2, 2-3, and 3-4 was 91.3°, 181.7° and −88.2°;

FIG. 7 is a graph of a complex conjugate corrupted A-scan obtained experimentally;

FIG. 8 is a graph of a complex conjugate resolved A-scan with DC and conjugate suppression of 74.3 dB and 38.7 dB, respectively;

FIG. 9 is a complex conjugate corrupted image of a fovea;

FIG. 10 is a complex conjugate resolved image of a fovea obtained in accordance with the subject matter disclosed herein;

FIG. 11 is a complex conjugate corrupted image of an optic nerve head;

FIG. 12 is a complex conjugate resolved image of an optic nerve head obtained in accordance with the subject matter disclosed herein;

FIG. 13 is a graph showing plots of meshes for each constraint on Gₚ(ψ,θ) and Hₚ(ψ,θ) as functions of ψ and θ to determine points of intersection;

FIG. 14 is a graph showing plots of the meshes shown in FIG. 13;

FIG. 15 is a graph showing a result of using a sinusoidal driving signal at 31.9 Vₚₚ and 323° phase offset, where the calculated mean phase step during one frame between buckets 1-2, 2-3, and 3-4 was 89.4°, 178.2° and −90.5°;

FIG. 16 is a graph of a complex conjugate unresolved A-scan;

FIG. 17 is a graph of a complex conjugate resolved A-scan obtained in accordance with the subject matter disclosed herein;

FIG. 18 is a complex conjugate corrupted image of the fovea;

FIG. 19 is a complex conjugate resolved image of the fovea obtained in accordance with the subject matter disclosed herein;

FIG. 20 is a complex conjugate corrupted image of the optic nerve head;

FIG. 21 is a complex conjugate resolved image of the optic nerve head obtained in accordance with the subject matter disclosed herein;

FIG. 22 is a graph of phase-shifted spectral interferograms acquired using four integrating bucket steps show reduced amplitudes as a result of fringe washout;

FIG. 23 is a graph showing that each integrating bucket is shifted by a value determined by the parameters of the driving signal for four quadrature steps;

FIG. 24 is a graph showing complex conjugate corrupted and resolved A-scans with DC and complex conjugate suppression of 72.5 and 34.7 dB, respectively, and fringe washout of 3.2 dB;

FIG. 25 is a complex conjugate corrupted image of the optic nerve head; and

FIG. 26 is a complex conjugate resolved image of the optic nerve head obtained in accordance with the subject matter disclosed herein.

### DETAILED DESCRIPTION

Methods, systems, and computer program products are disclosed that use integrating buckets techniques to provide improvements for removing undesired artifacts in Fourier domain optical coherence tomography (FDOCT) systems. FDOCT images can be corrupted by complex conjugate artifacts such that positive and negative distances cannot be uniquely resolved. Typical FDOCT practice avoids this issue by utilizing half of the available imaging depth. However, imaging of extended pathologies can benefit from full field imaging since sensitivity is limited by the characteristic roll-off associated with the finite spectral resolution of SDOCT systems. Complex conjugate resolved images require acquiring phase and amplitude interferometric data. As described herein, methods, systems, and computer program products are provided for high-speed phase shifted interferogram acquisition using integrating buckets algorithm borrowed from phase-shift interferometry.

In some embodiments of the subject matter disclosed herein, FDOCT interferometers and computer program products for removing undesired artifacts in FDOCT systems use sinusoidal phase modulation. A variable phase delay can be introduced between a reference arm and a sample arm of an FDOCT interferometer using sinusoidal phase modulation. An interferometric intensity signal can be acquired using an integrating buckets technique. The interferometric intensity signal can be resolved to remove undesired artifacts. The FDOCT may include spectral domain optical coherence tomography (SDOCT).

The systems and methods disclosed herein can provide such improvements by sinusoidally driving a reference arm PZT and acquiring phase shifted interferograms by use of an integrating buckets algorithm. The systems and methods disclosed herein can be provided at low cost, can be simple to implement, and can allow for high-speed, in vivo, complex conjugate resolved imaging of a sample.

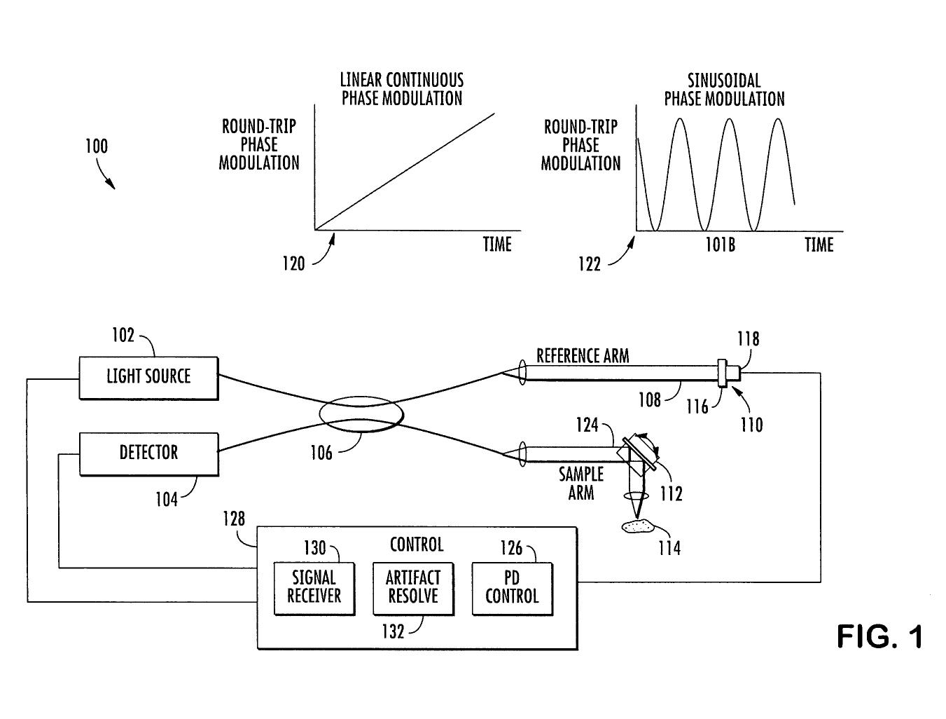

FIG. 1 is a schematic block diagram illustrating an FDOCT system generally designated 100 including a PZT element in accordance with the subject matter disclosed herein. Referring to FIG. 1, system 100 includes a light source 102, a detector 104, a fiber coupler 106, a reference delay 108, a piezo-mirror combination generally designated 110, beam steering 112, and a sample 114. Light source 102 can include a broadband light source. Detector 104 can include a spectrometer illuminating a multichannel detector, such as a linear charge-coupled device (CCD) array. Piezo-mirror combination 110 is located in the reference arm of the interferometer, which can include a mirror 116 and a piezoelectric element 118.

Referring to the graphs shown in FIG. 1, piezo-electric mirror combination 110 can be used to implement sinusoidal phase modulation by, for example, having PCT element 118 continuously scan mirror 116 back and forth in a sinusoidal pattern (as shown by the graph generally designated 122). It will be understood that although piezo-mirror combination 110 is provided in reference arm 108, embodiments of the subject matter disclosed herein are not limited to this configuration. For example, piezo-mirror combination 110 can be provided in a sample arm 124.

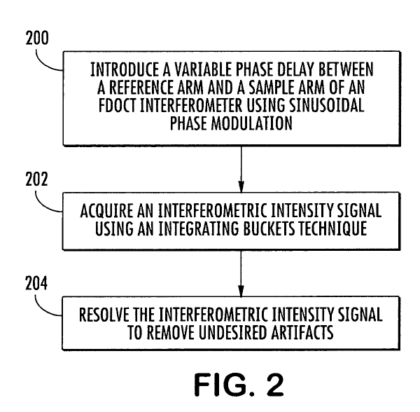

FIG. 2 is a flow chart illustrating an exemplary process for removing undesired artifacts in an FDOCT system according to an embodiment of the subject matter disclosed herein. In this example, reference is made to FDOCT system 100 shown in FIG. 1. Referring to FIGS. 1 and 2, a variable phase delay between reference arm 108 and sample arm 124 of the FDOCT interferometer is introduced using sinusoidal phase modulation (block 200). The variable phase delay can be provided by use of PZT element 118 to sinusoidally vibrate reflector 116. Alternative to introducing the variable delay in a reference arm, the variable delay may be introduced in a sample arm of the FDOCT interferometer by any suitable technique known to those of skill in the art.

PZT element 118 can be controlled by a phase delay control function 126 of an FDOCT interferometer control unit 128, which may be a computer configured with suitable functions and input/output devices for operating the interferometer. Phase delay control function 126 can be configured to communicate a sinusoidal PZT driving signal to PZT element 118 for modulating the reference delay. The reference delay can be modulated sinusoidally during N integration buckets per modulation.

In one example, considering a spectrometer-based SDOCT system containing a sinusoidally vibrating mirror in the reference arm, the spectral interferometric SDOCT signal from a summation of m discrete sample reflectors each with reflectivity Aₘ and position Δzₘ is given by:

$${s}_{p} ( k , t ) = {\sum }_{m = 1}^{M} {A}_{m} cos [ 2 k Δ {z}_{m} + ψ sin ( ω t + θ ) ] . \qquad ( 1 )$$

In equation (1), ψ and θ are the amplitude and phase, respectively, of the vibrating mirror. The sinusoid frequency for N buckets is ω=2π/(N(τ+Δτ)). Any other suitable sinusoidal signal can be applied to the vibrating mirror. Detector 104 can be used to acquire or measure the spectral interferometric SDOCT signal. Further, detector 104 can be configured to communicate the acquired signal to control unit 128 for further processing to remove undesired artifacts.

In block 202, an interferometric intensity signal is acquired using an integrating buckets technique, which generally operates by integrating a charge acquired by a device such as a CCD over a portion of the cyclical phase modulation. The integrating buckets technique can include determining an integrating bucket over an integration time of detector 104. In particular, a signal receiver 130 of control unit 128 can be configured to receive the spectral interferometric signal measured by detector 104 over an integration time τ. The spectral interferometric SDOCT signal acquired by detector 104 can be phase shifted as a function of the amplitude and phase offset of the sinusoidal PZT driving signal. The amplitude and phase can be optimized for DC and complex conjugate artifact removal and minimal fringe washout.

Given this time-varying modulating signal, the interferometric intensity measured by the CCD (or detector) is the “integrating bucket” signal corresponding to the interferometric signal integrated over the acquisition time of the camera (detector), τ:

$$I ( k ) = ( \frac{1}{τ} ) {\int }_{( p - 1 ) ( τ + Δ τ )}^{( p - 1 ) ( τ + Δ τ ) + τ} {s}_{p} ( k , t ) d t \\ p = 1 … N . \qquad ( 2 )$$

In equation (2), Δτ is any time delay of the CCD between sequential A-scans (i.e., camera read-out time), and

$$ω = \frac{2 π}{N ( τ + Δτ )}$$

for N phase steps.

Rewriting the inteferometric signal sₚ(k,t) as a sum of Fourier components using Bessel functions of the first kind, the integration in equation (2) can be carried out as (considering a single reflector for simplicity):

I=Aₘ{cos [2kΔzₘ]Gₚ(ψ,θ)−sin [2kΔzₘ]Hₚ(ψ,θ)}. (3)

In equation (3), Gₚ(ψ,θ) and Hₚ(ψ,θ) are the time-averaged values of the phase modulating signal for the p^{th} integrating bucket and can be represented by the following equations:

$$\begin{matrix}{G}_{p} ( ψ , θ ) = {J}_{0} ( ψ ) + N ( τ + Δτ ) / ( 2 πτ ) {\sum }_{n = 1}^{+ ∞} {J}_{2 n} ( ψ ) / n \{ sin [ 2 n ( 2 π / N ( ( p - 1 ) + τ / ( τ + Δτ ) ) + θ ) ] - sin [ 2 n ( 2 ( p - 1 ) π / N + θ ) ] \} , \\ and & ( 4 ) \\ {H}_{p} ( ψ , θ ) = - N ( τ + Δ τ ) / ( τ π ) {\sum }_{n = 0}^{+ ∞} {J}_{2 n + 1} ( ψ ) / ( 2 n + 1 ) \{ cos [ ( 2 n + 1 ) ( 2 π / N ( ( p - 1 ) + τ / ( τ + Δ τ ) ) + θ ) ] - cos [ ( 2 n + 1 ) ( 2 ( p - 1 ) π / N + θ ) ] \} . & ( 5 )\end{matrix}$$

By setting the constraints GP (ψ,θ)=cos [φₚ] and Hₚ(ψ,θ)=sin [φₚ], equation (3) reduces to a measured inteferometric signal with a constant phase shift, φₚ, for each p^{th} step. Values for ψ and θ can then be derived to satisfy these constraints and optimized to reduce fringe washout due to axial motion during each A-scan. Phase shift φₚ can be converted to axial displacement by zₚ=φₚ/(2k₀), where k₀ is the central wavenumber of the system. Using the sum of angles definition, the recorded interferometric signal becomes discretely stepped cos [α±β]=cos α cos β±sin α sin β (sum of angles), I_{D}=Aₘ{cos [2kΔzₘ]Gₚ(ψ,θ)−sin [2kΔzₘ]Hₚ(ψ,θ)}=Aₘ cos [2kΔzₘ+φₚ] (detected photocurrent of p^{th} phase step of m^{th} reflector).

In another example, Gₚ(ψ,θ) and Hₚ(ψ,θ) can be represented by the following equations:

$$\begin{matrix}{G}_{p} ( ψ , θ ) = ( \frac{1}{τ} ) {\int }_{( p - 1 ) ( τ + Δ τ )}^{( p - 1 ) ( τ + Δ τ ) + τ} \{ {J}_{0} ( ψ ) + 2 {\sum }_{n = 1}^{+ ∞} {J}_{2 n} ( ψ ) cos [ 2 n ( ω t + θ ) \} d t \\ {J}_{0} ( ψ ) + ( \frac{N ( τ + Δ τ )}{2 τπ} ) {\sum }_{n = 1}^{+ ∞} \frac{{J}_{2 n} ( ψ )}{n} * \{ \begin{matrix}sin [ 2 n ( \frac{2 π}{N} ( ( p - 1 ) + \frac{τ}{τ + Δ τ} ) + θ ) ] - \\ sin [ 2 n ( \frac{2 ( p - 1 ) π}{N} + θ ) ]\end{matrix} \} , \\ and & ( 6 ) \\ {H}_{p} ( ψ , θ ) = ( \frac{1}{τ} ) {\int }_{( p - 1 ) ( τ + Δ τ )}^{( p - 1 ) ( τ + Δ τ ) + τ} \{ 2 {\sum }_{n = 0}^{+ ∞} {J}_{2 n + 1} ( ψ ) cos [ ( 2 n + 1 ) ( ω t + θ ) ] \} d t = - ( \frac{N ( τ + Δ τ )}{τπ} ) {\sum }_{n = 0}^{+ ∞} \frac{{J}_{2 n + 1} ( ψ )}{2 n + 1} \{ cos [ ( 2 n + 1 ) ( \frac{2 π}{N} ( ( p - 1 ) + \frac{τ}{τ + Δ τ} ) + θ ) ] - cos [ ( 2 n + 1 ) ( \frac{2 ( p - 1 ) π}{N} + θ ) ] \} . & ( 7 )\end{matrix}$$

In block 204, an artifact resolve function 132 resolves the interferometric intensity signal to remove undesired artifacts. The measured interferometric signal can then be complex conjugate resolved using a quadrature projection algorithm which is insensitive to chromatic or mis-calibrated phase shifts, which may be directly applied to the integrating bucket-derived phase shifts without modification. Quadrature projection can remove phase noise due to chromaticity of the source and system instability by subtracting the inherent phase offset for each frame. Quadrature components are then calculated for each phase shifted signal by a Fourier decomposition into real and imaginary components. The image can then be complex conjugate resolved by combining the real and imaginary components for each reflector.

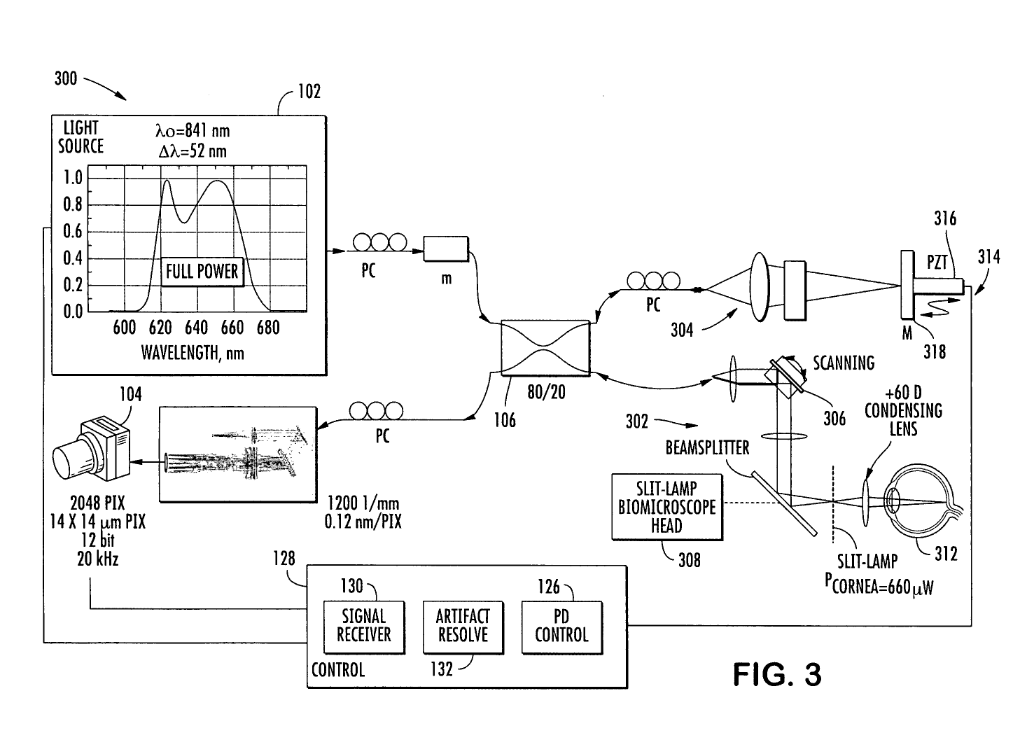

The subject matter disclosed herein may be implemented in an FDOCT retinal imaging system. FIG. 3 is a schematic block diagram illustrating an FDOCT retinal imaging system generally designated 300 in accordance with the subject matter disclosed herein. Further, experiments discussed herein were performed using a system in accordance with the system shown in FIG. 3. Referring to FIG. 3, system 300 has a central wavelength at 840 nm and a bandwidth of 49 nm, although any other suitable central wavelength and bandwidth may be utilized. Further, system 300 includes a sample arm generally designated 302 and a sinusoidally oscillating reference arm generally designated 304. Sample arm 302 is a slit-lamp with a galvanometer scanner pair and relay optics to allow for convenient patient imaging. Sample arm 302 can include lens, a scanning component 306, a slit-lamp biomicroscope head 308, slit lamp generally designated 310, and other suitable components for imaging a retina of an eye 312.

Reference arm 304 is terminated with a piezo-mirror combination generally designated 314, where a PZT element 316 is driven by a phase control function 126 to sinusoidally oscillate a mirror 318. PZT element 316 as a displacement range of 4.6±1.5 μm at 150 V and internal capacitance of 0.02 μF. Function 126 is synchronized using the output TTL from a CCD generally designated 320.

The spectral interferometric signal can be acquired by detector 104. In this example, detector 104 is a 1024-pixel line-scan CCD. Suitable software contained on control unit 128 can provide real-time acquisition and display functionality. In one experiment, images of the retina were acquired at a 1024 pixels/A-scan at an integration time of 18 μs with a time delay of ˜1 μs per A-scan (corresponding to an A-scan capture rate of 51.9 kHz). An integrating bucket phase stepping algorithm was solved for four integrating buckets and a galvanometer was programmed to acquire four sequential A-scans per lateral location. Densely sampled 3000 line images were captured at 4.33 frames/second. A complex conjugate suppression quadrature projection algorithm was computed during post-processing using MATLAB® 7.1 software available from The MathWorks, Inc., of Natick, Me. Mirror 318 and sample arm galvanometers were aligned to reduce phase noise.

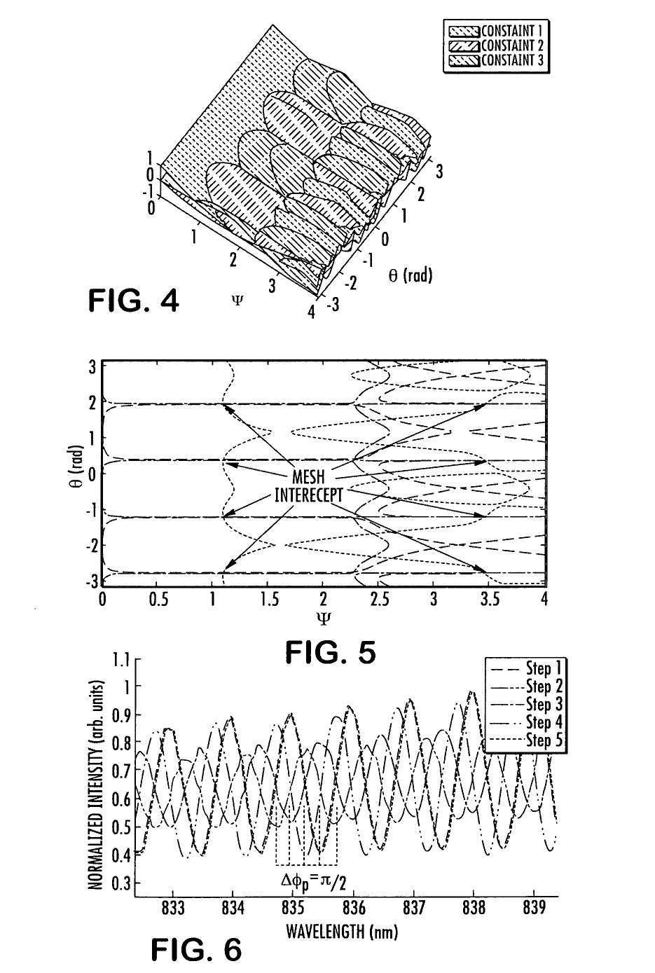

Meshes for Gₚ(ψ,θ) and Hₚ(ψ,θ) (shown in FIG. 4) were plotted to determine values satisfying constraints for ψ and θ (shown in FIG. 5) for the desired phase steps. In particular, FIG. 4 is a graph showing plots of meshes for each constraint on Gₚ(ψ,θ) and Hₚ(ψ,θ) as functions of ψ and θ to determine points of intersection. Mesh intercepts with smallest driving signal amplitude were used to minimize fringe washout.

Interferograms acquired for integrating bucket phase steps, 1, 4 and 2, 3 showed decreased fringe amplitude (as shown in FIG. 6) as a result of washout, corresponding to phase steps that occurred during maximum velocity portions of PZT mirror motion. FIG. 6 is a graph showing a result of using a sinusoidal driving signal at 11.6 Vₚₚ and 341° phase offset, where the calculated mean phase step during one frame between buckets 1-2, 2-3, and 3-4 was 91.3°, 181.7° and −88.2°. The overall washout, after applying quadrature projection algorithm, was a decreased peak intensity of 4.82 dB for a single reflector.

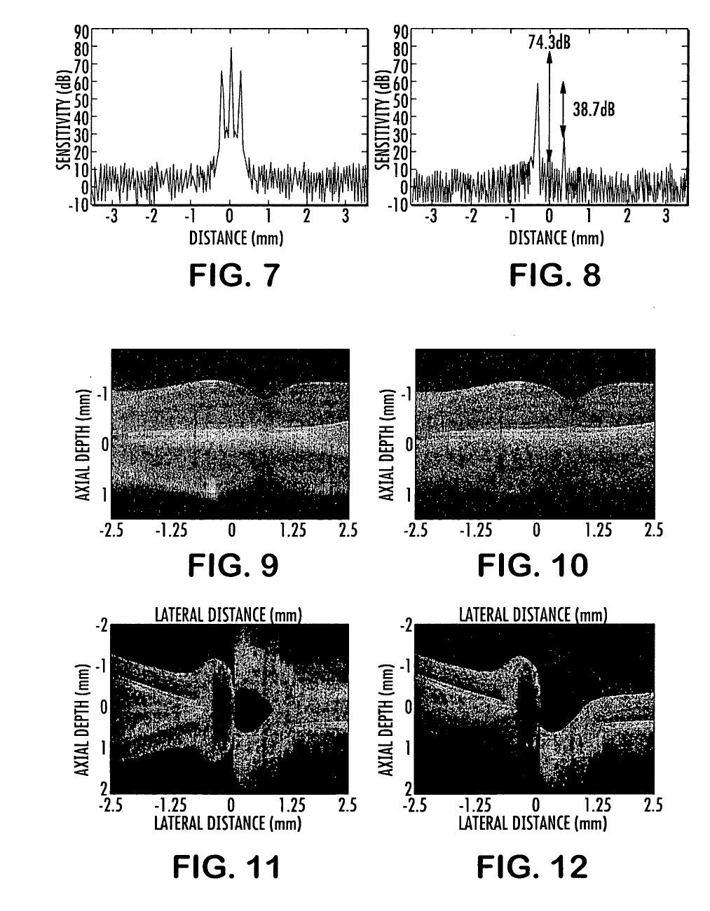

Integrating bucket algorithm performance was quantified using a calibrated reflector in the sample arm. A-scans, acquired at the full scan rate of 51.9 kHz, were complex conjugate resolved. For example, FIG. 7 is a graph of a complex conjugate corrupted A-scan obtained experimentally. In contrast for example, FIG. 8 is a graph of a complex conjugate resolved A-scan with DC and conjugate suppression of 74.3 dB and 38.7 dB, respectively. Thus, the algorithm obtained a DC suppression of 74.3 dB and a conjugate artifact suppression of 38.7 dB.

The experiments include applying the integrating buckets algorithm to in vivo normal retina. In particular, in vivo B-scans of retina with 1024 pts/line, 3000 lines/frame, and 5 mm lateral distance were obtained. FIGS. 9 and 10 are complex conjugate corrupted and resolved images, respectively, of the fovea. FIGS. 11 and 12 are complex conjugate corrupted and resolved images, respectively, of the optic nerve head. For most regions, complex conjugate artifacts were suppressed to the noise floor, although some artifact remained from strong reflecting surfaces. Improved contrast is shown in FIGS. 11 and 12 which demonstrate improved SNR from applying the quadrature projection algorithm.

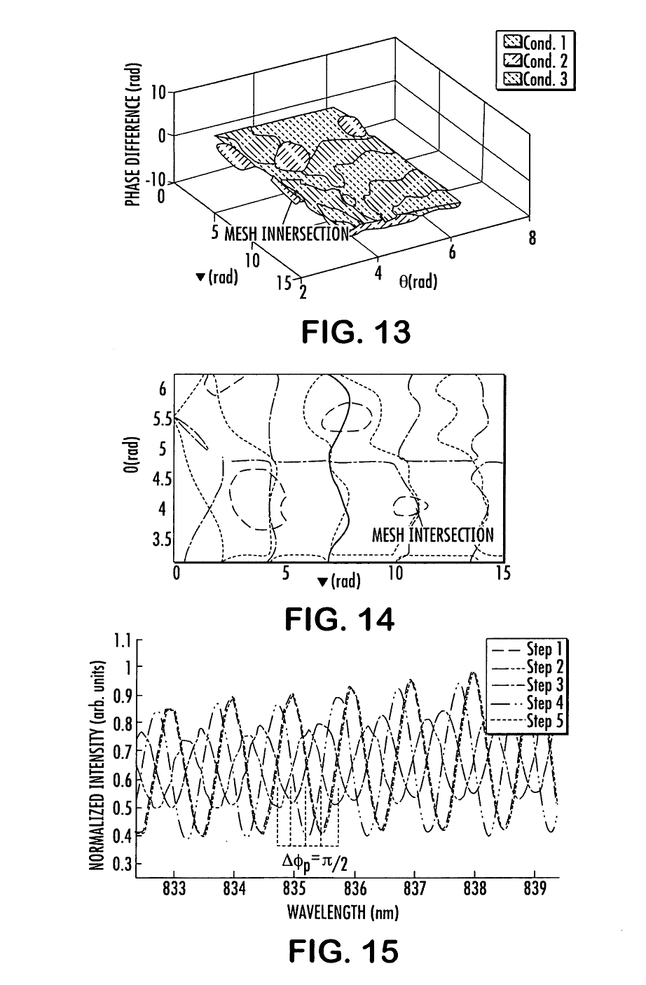

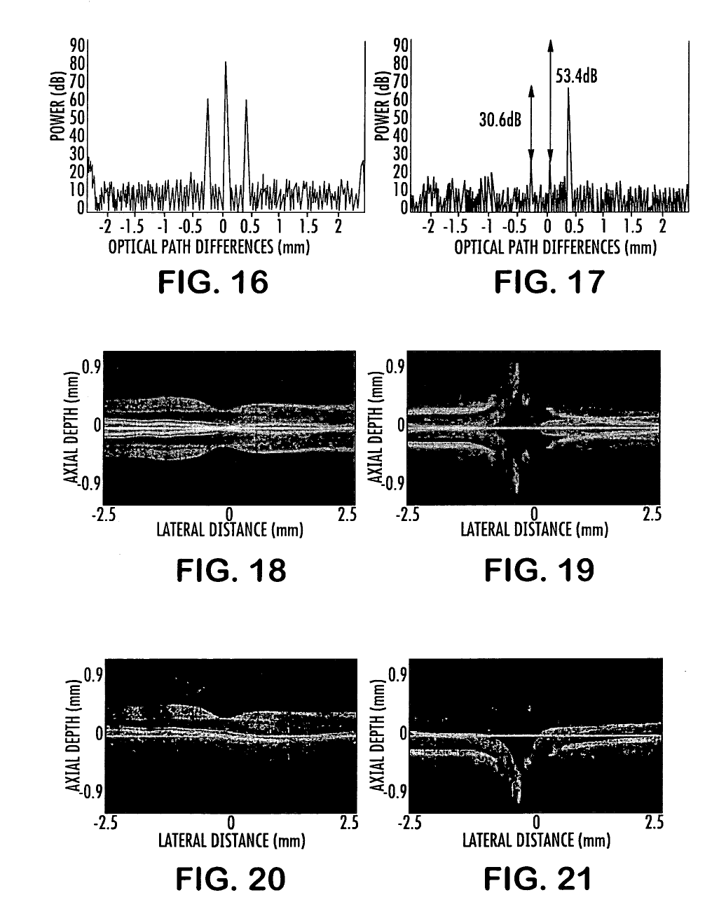

In another experiment with the system shown in FIG. 3, images were acquired by a 1024 pixel subset of a 2048-pixel line-scan CCD for real-time data acquisition, processing, archiving, and display. In another experiment, using a sinusoidal driving signal at 31.9 Vₚₚ and 323° phase offset, calculated mean phase setup during one frame between buckets 1-2, 2-3, and 3-4 was 89.4°, 178.2°, and −90.5°. Equation (3) was solved such that the relative phase step between buckets 1-2, 2-3, and 3-4 were 90°, 180°, and −90°, respectively. The conditions were satisfied at ψ=11.3 rad and θ=3.92 rad. Meshes for φ₃₋₂−φ₄₋₃=π/2 and φ₄₋₃−φ₂₋₁=0 were plotted (shown in FIG. 13) to determine values where all constraints were satisfied for ψ and θ (shown in FIG. 14). FIGS. 16 and 17 are graphs of complex conjugate unresolved and resolved A-scans, respectively. At the full A-scan rate of 17.5 kHz, the algorithm obtained DC suppression of 53 dB and complex conjugate artifact suppression of 30 dB. FIGS. 18 and 19 are in vivo B-scans of retina with 1024 pts/line, 3000 lines/frame and 5 mm lateral distance. In particular, FIGS. 18 and 19 are complex conjugate and resolved images, respectively, of the fovea. FIGS. 20 and 21 are complex conjugate corrupted and resolved images, respectively, of the optic nerve head.

In yet another experiment with the system shown in FIG. 3, images were acquired by a system with central wavelength at 841 nm and a bandwidth of 52 nm. The PZT element had a displacement range of 17.4±2.0 μm (150 V, Cᵢₙₜₑᵣₙₐₗ=1.40±0.28 μF). Interferometric signals were captured using a 1024 pixel line-scan CCD. Data were acquired at 1024 pixels/A-scan with an integration time of 18 μs and a readout time delay of ˜1 μs per A-scan (52 kHz A-scan rate). The integrating bucket acquisition algorithm was solved for four quadrature steps, and the galvanometers were programmed to acquire all four sequential, phase-shifted A-scans per lateral position, reducing A-scan rate to 13 kHz.

In this experiment, acquired integrating bucket spectral interferograms showed decreased fringe amplitude as compared with acquisition with a stationary reference mirror, due to fringe washout. Phase steps 1-2 and 3-4 yielded amplitude decreases of 1.2 dB, while steps 2-3 and 1-4 showed decreases of 6.7 dB. These phase steps corresponded to phase shifts of φ=π/2 and φ=π, respectively, where more significant washout corresponded to larger phase shifts during which the integrating bucket was acquiring over the high-velocity linear portions of the driving sinusoid. Smaller phase steps corresponded to integrating periods over the lower-velocity peak and troughs of the driving signal.

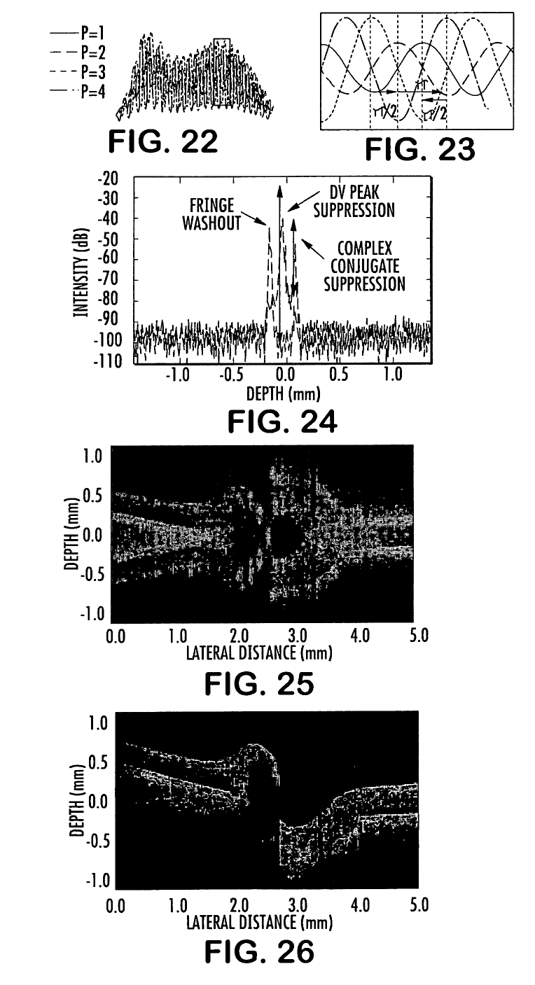

FIGS. 22-24 are graphs showing the results of the experiment. Referring to FIG. 22, phase-shifted spectral interferograms acquired using four integrating bucket steps show reduced amplitudes as a result of fringe washout. In FIG. 23, each integrating bucket is shifted by a value determined by the parameters of the driving signal (ψ=22.3Vₚₚ, θ=341 degrees) for four quadrature steps. FIG. 24 shows complex conjugate corrupted and resolved A-scans with DC and complex conjugate suppression of 72.5 and 34.7 dB, respectively, and fringe washout of 3.2 dB.

Maximum complex conjugate suppression was measured using a −60 dB calibrated reflector in the sample arm. Complex conjugate corrupted and resolved A-scans are presented in FIG. 24. Integrating bucket interferograms acquired at the full A-scan rate of 52 kHz produced DC and complex conjugate suppression of 72.5 and 34.7 dB, respectively. Fully resolved A-scan peak amplitudes showed overall amplitude washout of 3.2 dB, which is less than the maximum washout for the φ=π or phase steps, illustrating the signal-to-noise ratio improvement through averaging effects inherent in the quadrature projection algorithm.

Complex conjugate unresolved and revolved images of optic nerve head are shown in FIGS. 25 and 26, respectively. These figures illustrate DC and CCA suppression in in vivo images of normal human retina. These images were densely sampled at 3000 lines/frame and complex conjugate resolved using four quadrature integrating bucket steps, corresponding to an imaging rate of 4.3 images/s. All image intensities were normalized to 36 dB dynamic range, and for most regions in the images the CCA was suppressed to the noise floor, although some artifact remains in strongly reflecting regions of the optic nerve head shown in FIG. 26.

Thus, the system used in the experiments acquired discrete phase shifted interferograms using a sinusoidally oscillating reference mirror with integrating buckets algorithm. The technique was demonstrated for four phase steps on a calibrated reflector and in vivo normal retina.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for removing undesired artifacts in a Fourier domain optical coherence tomography (FDOCT) system using an integrating buckets technique, the method comprising:
introducing a variable phase delay between a reference arm and a sample arm of an FDOCT interferometer using sinusoidal phase modulation;
acquiring an interferometric intensity signal using an integrating buckets technique; and
resolving the interferometric intensity signal to remove undesired artifacts.

2. The method of claim 1 wherein introducing the variable phase delay comprises introducing the variable delay in one of the reference arm and the sample arm of the FDOCT interferometer.

3. The method of claim 1 wherein introducing the variable phase delay comprises introducing the variable phase delay using a piezoelectric transducer associated with a reflector.

4. The method of claim 1 wherein FDOCT comprises Spectral domain optical coherence tomography (SDOCT).

5. The method of claim 1 wherein introducing the variable phase delay comprises introducing the variable phase delay using a sinusoidally vibrating piezoelectric transducer to vibrate a reflector associated with the reference arm.

6. The method of claim 5 comprising producing a spectral interferometric signal by vibration of the reflector, the spectral interferometric signal being represented by:
$${s}_{p} ( k , t ) = {\sum }_{m = 1}^{M} {A}_{m} cos [ 2 k Δ {z}_{m} + ψ sin ( ω t + θ ) ] ,$$
where m is a number of reflectors each with reflectivity Aₘ and position Δzₘ, and ψ and θ are the amplitude and phase, respectively, of the vibrating reflector.

7. The method of claim 5 wherein acquiring the interferometric intensity signal comprises using a detector of the FDOCT interferometer to acquire a spectral interferometric signal.

8. The method of claim 7 wherein using an integrating buckets technique comprises determining an integrating bucket over an integration time of the detector.

9. The method of claim 8 wherein the integrating bucket over the integration time of the detector is represented by:
$$I ( k ) = ( \frac{1}{τ} ) {\int }_{( p - 1 ) ( τ + Δ τ )}^{( p - 1 ) ( τ + Δ τ ) + τ} {s}_{p} ( k , t ) d t \\ p = 1 … N ,$$
where Δτ is any time delay of the CCD between sequential A-scans (i.e., camera read-out time), and
$$ω = \frac{2 π}{N ( τ + Δ τ )}$$
for N phase steps.

10. The method of claim 1 wherein resolving the interferometric intensity signal comprises using a quadrature projection algorithm to resolve the undesired artifacts.

11. The method of claim 1 wherein the undesired artifacts comprise artifacts selected from the group consisting of DC, autocorrelation, and complex conjugate artifacts.

12. A Fourier domain optical coherence tomography (FDOCT) system using an integrating buckets technique to remove undesired artifacts, the system comprising:
a reference arm and a sample arm of an FDOCT interferometer;
a phase controller configured to introduce a variable phase delay between the reference arm and the sample arm using sinusoidal phase modulation;
a signal receiver configured to acquire an interferometric intensity signal using an integrating buckets technique; and
an artifact resolve function configured to resolve the interferometric intensity signal to remove undesired artifacts.

13. The FDOCT system of claim 12 wherein the phase controller is configured to introduce the variable delay in one of the reference arm and the sample arm of the FDOCT interferometer.

14. The FDOCT system of claim 12 wherein the phase controller is configured to control a piezoelectric transducer associated with a reflector to introduce the variable phase delay.

15. The FDOCT system of claim 12 wherein FDOCT comprises Spectral domain optical coherence tomography (SDOCT).

16. The FDOCT system of claim 17 wherein the phase controller is configured to control a piezoelectric transducer to sinusoidally vibrate a reflector associated with the reference arm.

17. The FDOCT system of claim 16 wherein the phase controller is configured to control the piezoelectric transducer to sinusoidally vibrate the reflector to produce a spectral interferometric signal, the spectral interferometric signal being represented by:
$${s}_{p} ( k , t ) = {\sum }_{m = 1}^{M} {A}_{m} cos [ 2 k Δ {z}_{m} + ψ sin ( ω t + θ ) ] ,$$
where m is a number of reflectors each with reflectivity Aₘ and position Δzₘ, and ψ and θ are the amplitude and phase, respectively, of the vibrating reflector.

18. The FDOCT system of claim 15 wherein the signal receiver is configured to communicate with a detector of the FDOCT interferometer to acquire a spectral interferometric signal.

19. The FDOCT system of claim 18 wherein the artifact resolve function is configured to use the integrating buckets technique to determine an integrating bucket over an integration time of the detector.

20. The FDOCT system of claim 19 wherein the integrating bucket over the integration time of the detector is represented by:
$$I ( k ) = ( \frac{1}{τ} ) {\int }_{( p - 1 ) ( τ + Δ τ )}^{( p - 1 ) ( τ + Δ τ ) + τ} {s}_{p} ( k , t ) d t \\ p = 1 … N ,$$
where Δτ is any time delay of the CCD between sequential A-scans (i.e., camera read-out time), and
$$ω = \frac{2 π}{N ( τ + Δ τ )}$$
for N phase steps.

21. The FDOCT system of claim 12 wherein the artifact resolve function is configured to use a quadrature projection algorithm to resolve the undesired artifacts.

22. The FDOCT system of claim 12 wherein the undesired artifacts comprise artifacts selected from the group consisting of DC, autocorrelation, and complex conjugate artifacts.

23. A computer program product comprising computer executable instructions embodied in a computer readable medium for performing steps comprising:
introducing a variable phase delay between a reference arm and a sample arm of an FDOCT interferometer using sinusoidal phase modulation;
acquiring an interferometric intensity signal using an integrating buckets technique; and
resolving the interferometric intensity signal to remove undesired artifacts.

24. The computer program product of claim 23 wherein introducing the variable phase delay comprises introducing the variable delay in one of the reference arm and the sample arm of the FDOCT interferometer.

25. The computer program product of claim 23 wherein introducing the variable phase delay comprises introducing the variable phase delay using a piezoelectric transducer associated with a reflector.

26. The computer program product of claim 23 wherein FDOCT comprises Spectral domain optical coherence tomography (SDOCT).

27. The computer program product of claim 23 wherein introducing the variable phase delay comprises introducing the variable phase delay using a sinusoidally vibrating piezoelectric transducer to vibrate a reflector associated with the reference arm.

28. The computer program product of claim 27 comprising producing a spectral interferometric signal by vibration of the reflector, the spectral interferometric signal being represented by:
$${s}_{p} ( k , t ) = {\sum }_{m = 1}^{M} {A}_{m} cos [ 2 k Δ {z}_{m} + ψ sin ( ω t + θ ) ] ,$$
where m is a number of reflectors each with reflectivity Aₘ and position Δzₘ, and ψ and θ are the amplitude and phase, respectively, of the vibrating reflector.

29. The computer program product of claim 27 wherein acquiring the interferometric intensity signal comprises using a detector of the FDOCT interferometer to acquire a spectral interferometric signal.

30. The computer program product of claim 29 wherein using an integrating buckets technique comprises determining an integrating bucket over an integration time of the detector.

31. The computer program product of claim 30 wherein the integrating bucket over the integration time of the detector is represented by:
$$I ( k ) = ( \frac{1}{τ} ) {\int }_{( p - 1 ) ( τ + Δ τ )}^{( p - 1 ) ( τ + Δ τ ) + τ} {s}_{p} ( k , t ) d t \\ p = 1 … N ,$$
where Δτ is any time delay of the CCD between sequential A-scans (i.e., camera read-out time), and
$$ω = \frac{2 π}{N ( τ + Δ τ )}$$
for N phase steps.

32. The computer program product of claim 23 wherein resolving the interferometric intensity signal comprises using a quadrature projection algorithm to resolve the undesired artifacts.

33. The computer program product of claim 23 wherein the undesired artifacts comprise artifacts selected from the group consisting of DC, autocorrelation, and complex conjugate artifacts.
